(19) United States
(12) Patent Application Publication
(10) Pub. No.: US 2010/0007588 A1
(43) Pub. Date: Jan. 14, 2010

(54) SYSTEM AND METHOD FOR LED DEGRADATION AND TEMPERATURE COMPENSATION

(75) Inventors: Anthony P. Zygmunt, Racine, WI (US); Chein Hsun Wang, Milwaukee, WI (US); J. Anthony Spies, Waterloo, WI (US)

Correspondence Address: FOLEY & LARDNER LLP, 777 EAST WISCONSIN AVENUE, MILWAUKEE, WI, 53202-5306, US

(73) Assignee: Adaptive Micro Systems LLC

(21) Appl. No.: 12/170,318

(22) Filed: Jul. 9, 2008

(51) Int. Cl. G09G 3/32

(52) U.S. Cl. 345/83; 345/82

(57) ABSTRACT

A display for generating changing or still images is shown and described. The display includes a plurality of display light emitting diodes (LEDs), each display LED generating light at an intensity related to current applied thereto. The display further includes a circuit which controls the current applied to each display LED to generate at least a portion of an image on the display, wherein the current is changed to change the portion of the image. The display yet further includes at least one reference LED coupled to the circuit, wherein the circuit applies a current to the reference LED dependent upon the current applied to at least one display LED, the circuit periodically applying a reference current to the reference LED. The display yet further includes a detector optically coupled to the reference LED to generate an intensity signal representative of the intensity of the reference LED when the reference current is applied thereto, the circuit monitoring the intensity signal to control the current applied to the display LEDs to compensate for changes in the relationship between the intensity of display LEDs and the current applied to the display LEDs.

### BACKGROUND

This application generally relates to controllers and methods for controlling light emitting diode (LED) displays. The application relates more specifically to circuits, systems, and methods for LED degradation and temperature compensation.

Illuminating displays have been used to convey information, provide lighting, and/or to entertain observers. While conventional illuminating displays were typically static arrangements of incandescent or fluorescent lamps, more recent illuminating displays are dynamic (e.g., animated, information-changing, etc.) or programmed and/or typically use different illuminating technology. One such technology that has increasingly been used with illuminating displays is LED technology. An LED is a generally a chip of semi-conducting material configured to emit electroluminescent light. LED signs typically use a relatively large number of LEDs arranged in an orderly or unorderly fashion. Manufacturing impurities may result in the need to identify batches of LEDs having similar natural color or brightness characteristics. For a variety of reasons ranging from aesthetic to practical (e.g., sign readability, etc.), it is desirable for a sign to be able to produce consistent and uniform observable color and brightness levels.

LED displays are used in particular for outdoor advertising (e.g. digital billboards, on-premise LED signs) due to high visibility and the ability to quickly and easily change displayed content. Conventional LED signs may be exposed to environmental conditions, including but not limited to extreme temperatures, strong winds, and high humidity. LED signs may be operated at high temperatures due to self generated heat and solar heat. Internal chassis temperatures may reach as high as 70 C without air conditioning. High temperatures can cause color shifting and decrease LED output intensity. The temperature dependence of the output intensity of LEDs often varies for red, green and blue LEDs. Therefore, calibrated colors (observable colors combining red, green, and blue LEDs) may shift under different temperatures.

The prolonged operation of outdoor LED signs at high temperatures may cause degradation in the output intensity of each LED. Additionally, outdoor LED signs may be operated at low operating temperatures. At low operating temperatures, output intensity may increase at different rates for each color of LED. This increase in output intensity may cause color matching problems. For LED signs used for advertising, it is ideal that LED signs appear in a correct color format. Spare parts are also a concern for LED signs. LEDs will degrade over time, changing the appearance of a sign. When a new calibrated driver board is added to an existing sign, a tiling or patchwork effect may be seen.

### SUMMARY

The invention relates to a display for generating images (e.g., changing or still images). The display includes a plurality of display light emitting diodes (LEDs), each display LED generating light at an intensity related to current applied thereto. The display further includes a circuit which controls the current applied to each display LED to generate at least a portion of an image on the display, wherein the current is changed to change the portion of the image. The display yet further includes at least one reference LED coupled to the circuit, wherein the circuit applies a current to the reference LED dependent upon the current applied to at least one display LED, the circuit periodically applying a reference current to the reference LED. The display yet further includes a detector optically coupled to the reference LED to generate an intensity signal representative of the intensity of the reference LED when the reference current is applied thereto, the circuit monitoring the intensity signal to control the current applied to the display LEDs.

The invention also relates to a light emitting diode (LED) display. The display includes a reference LED corresponding to an LED color group of the display. The display also includes a circuit configured to drive the reference LED at a current the same as or related to current being provided to LEDs of the LED color group. The circuit is configured to vary the current provided to the reference LED with changes in the current being provided to LEDs of the LED color group. The display further includes a photodetector configured to measure the intensity of the light emitting from the reference LED when the circuit is driving the reference LED at a reference current level. The circuit is configured to compare the measured intensity to a stored, calculated, or stored and calculated intensity value determined to correspond with the reference current. The circuit is also configured to adjust the current provided to the LEDs of the LED color group of the display based on the comparison.

The invention further relates to a method for adjusting light emitter diode (LED) intensity of a display having a plurality of LEDs. The method includes the steps of driving the plurality of LEDs and driving a first LED coupled to the display at a first current approximating a measure of the current provided to the plurality of LEDs. The method further includes the step of measuring the intensity of the light emitting from the first LED when the first LED is driven at a first reference current. The method yet further includes the steps of comparing the measured intensity of the light emitting from the first LED to a first stored intensity level and using the comparison to adjust the current provided to the plurality of LEDs.

The invention further relates to a system for adjusting light emitting diode (LED) intensity of a display having a plurality of LEDs. The system includes a first LED at the display. The system yet further includes a circuit which determines an indicia of the current applied to the plurality of LEDs and to cause the first LED to be driven at a first current related to the indicia of current applied to the plurality of LEDs. The system yet further includes a first photodetector configured to periodically measure the intensity of the light emitting from the first LED when the first LED is driven at a first reference current. The circuit is further configured to compare the measured intensity of the light emitting from the first LED to a first stored intensity level. The circuit is yet further configured to use the comparison to adjust the current provided to the plurality of light emitting diodes.

### BRIEF DESCRIPTION OF THE FIGURES

The application will become more fully understood from the following detailed description, taken in conjunction with the accompanying figures, wherein like reference numerals refer to like elements, in which:

FIG. 1 is a perspective view of an illuminating display having an array of display panels, according to an exemplary embodiment;

FIG. 2A is a graph of temperature and intensity characteristics of LED colors, according to an exemplary embodiment;

FIG. 2B is a graph of temperature and photocurrent characteristics of a photodiode, according to an exemplary embodiment;

FIG. 3 is front view of a display panel board, according to an exemplary embodiment;

FIG. 4 is a rear view of a display panel board, according to an exemplary embodiment;

FIG. 5 is a close up perspective view of a reference LED and photo sensor assembly, according to an exemplary embodiment;

FIG. 6 is a block diagram of the display of FIG. 1, according to an exemplary embodiment;

FIG. 7 is a flow chart of an initial aging calibration process for the display, according to an exemplary embodiment;

FIG. 8 is a flow chart of an operating process for the display, according to an exemplary embodiment;

FIG. 9 is more detailed flow chart of the process shown in FIG. 8, according to an exemplary embodiment;

FIG. 10 is a flow chart of a temperature compensation process for the display, according to an exemplary embodiment; and

FIG. 11 is a flow chart of an aging compensation process for the display, according to an exemplary embodiment.

### DETAILED DESCRIPTION OF THE EXEMPLARY EMBODIMENTS

Referring generally to the figures, an illuminating or active display is shown that can be made of a plurality of display panels. The display can be configured to generate changing images, still images, and/or video images. Each panel can include a plurality of light emitting pixels. Each light emitting pixel can include a plurality of colored LEDs. The LEDs can be of different diode colors (e.g., each LED can be configured to emit a single color, each LED can have multiple color dies, etc.). Each display LED generates light at an intensity related to the current applied to the LED. The display further includes a circuit which controls the current applied to each display LED to generate at least a portion of an image on the display. Current is changed to change the image or a portion of the image. At least one reference LED is provided at the display and electrically coupled to the circuit. The circuit also applies a current to the reference LED, the reference current dependent upon the current applied to at least one display LED in normal operation. The circuit is configured to periodically apply a reference current to the reference LED. A photodetector is optically coupled to the reference LED and configured to generate an intensity signal representative of the intensity of the reference LED when the reference current is applied to the reference LED. The circuit is configured to receive the intensity signal and to control the current applied to the display LEDs during normal operation to compensate for an estimated change in the relationship between the intensity of display LEDs and the applied current applied to the display LEDs. The estimated change is based on a comparison of the intensity signal to a previously stored relationship between intensity and reference current.

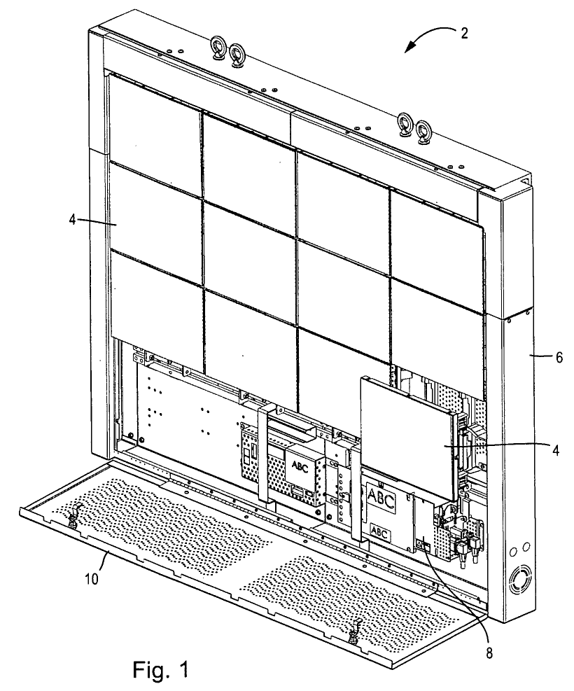

Referring to FIG. 1, a perspective view of an illuminating display 2 having a plurality of display panels 4 is shown, according to an exemplary embodiment. Illuminating display 2 may further include a display housing 6, a video distributor 8, and an electronics access panel 10. Display housing 6 may take any form (e.g., rectangular, circular, etc.) and may include an array of display panels 4 of any number or configuration. Display housing 6 may made of any material or a variety of materials suitable for housing LED electronics. Display 2, for example, has metal display housing 6 and a display panel array of four display panels 4 wide by three display panels high. Video distributor 8 (i.e., display driver board) generally stores, receives, and/or coordinates video data (e.g., via wireless communications, wired communications, etc.) for a plurality of display panels 4 and provides video signals to individual display panels 4 of display 2. Additional display electronics, wiring, cooling, structural features and/or other hardware or software features may also be included in display 2 that are not shown in FIG. 1 or the remaining figures. For example, a power input mechanism or power supply mechanism are not shown in detail but will likely be included with any illuminating display 2.

Each display panel 4 includes multiple LEDs and includes a set of reference LEDs 200 (shown in FIG. 5). The LEDs are typically of differing colors, and may be arranged in clusters. Reference LEDs 200 may be mounted inside display housing (e.g., chassis) 6 so that the operating temperature of the reference LEDs 200 may be close to the operating temperature of the LED display 2. According to other various exemplary embodiments, one or more reference LEDs 200 can be mounted outside the chassis. The reference LEDs can be mounted to structures of the chassis or any other structures. According to an exemplary embodiment, at least one reference LED is provided for each diode color and/or batch of like LEDs. According to yet other exemplary embodiments, multiple reference LEDs are provided for each diode color and/or batch of like LEDs.

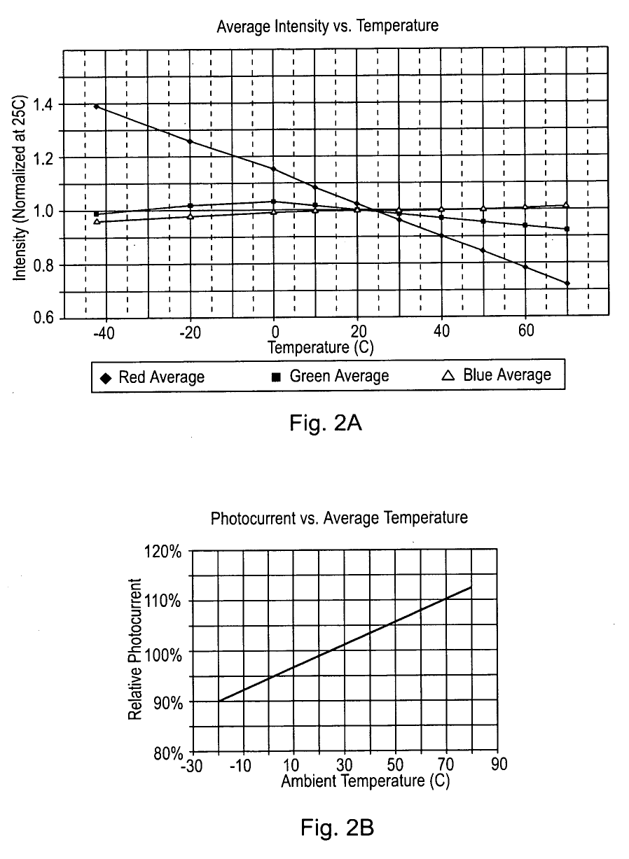

Referring to FIG. 2A, a graph of typical LED intensity readings with respect to temperature is shown. In FIG. 2A, current applied to the LEDs is held constant. The intensity of the LEDs has been normalized to 25 C, or room temperature. The intensity of the LEDs may vary with varying working conditions. For example, the intensity of a red LED may vary from around 40% over average to about 30% below average from −30 C to +70 C. The intensity of green LEDs may vary by 10% and blue LEDs may vary by 3%. Changes in operating temperature can change the relationship between current and intensity. Display panels are typically calibrated to have a white balance of D65 (6500K on the black body curve) at room temperature. If LED intensity is allowed to vary with temperature and/or age, the white balance can change, affecting the color correctness of the sign.

Referring to FIG. 2B, a graph showing how photodetector 206 (shown in subsequent Figures) varies with ambient temperature of a photodetector 206 is shown. The photodetector 206 is also temperature dependent, varying up to 20% from −20 C to 70 C.

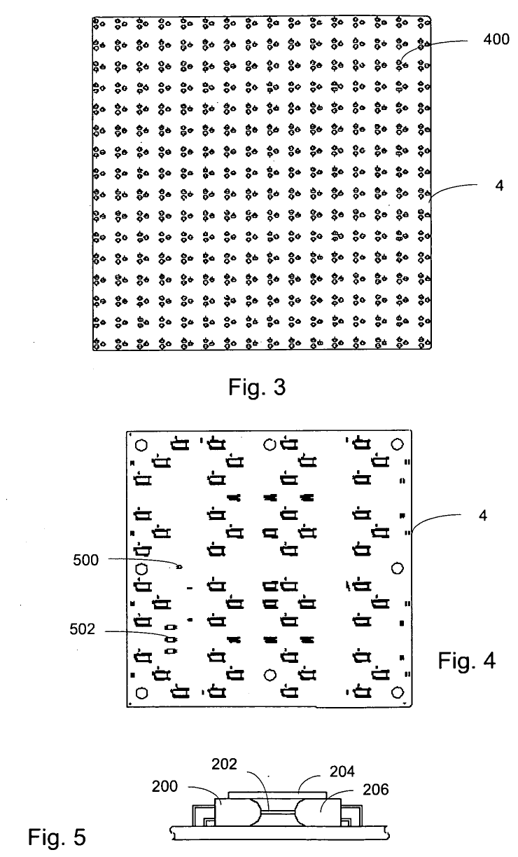

Referring to FIG. 3, a front view of a display panel 4 is shown. The display panel 4 may have a plurality of LED clusters 400. Each LED cluster 400 may comprise three LEDs of differing colors (e.g., red, green, blue) and be considered one pixel on the display panel. Alternatively, single LED units can be provided that have different dies for different colors and used in place of three LEDs per pixel. Display panel 4 is shown be 16 pixels wide by 16 pixels high. One driver module (e.g., a circuit configured to drive and/or control the pixels of a panel) may be used per display panel. LED clusters 400 may be of any number or configuration. For example, more than one diode may be provided for each color per cluster.

Referring to FIG. 4, a rear view of a display panel 4 is shown, according to an exemplary embodiment. Display panel 4 may include one or more reference LED clusters 502 and a temperature sensor 500. The reference LED clusters 502 may be fixed to the rear of display panel 4 so that the operating temperature of the reference LEDs 200 is the same as that of the LED clusters 400. According to other exemplary embodiments, reference LED clusters 502 may be fixed to a different structure of display panel 4, a housing for the display, or any other structure of the display. Temperature sensor 500 is shown as fixed to the rear of the display panel 4. Temperature sensor 500 is generally configured to measure operating temperature inside the display panel 4 (or to generate a signal relating to operating temperature or from which operating temperature can be derived). Temperature sensor 500 and reference LED cluster 502 may be of any number or configuration.

Referring to FIG. 5, a reference LED 200 and photodetector 206 are shown according to an exemplary embodiment. Reference LED 200 may be of construction similar to that of the display panel 4 LEDs. According to an exemplary embodiment the reference LED is matched to the a group of LEDs on the display panel (e.g., matched to a red, green, or blue color group). At least one reference LED may be matched to a “batch” of like LEDs that have been grouped for having similar characteristics. Photodetector 206 is shown as positioned to face reference LED 200. Additionally, photodetector 206 is optically coupled to reference LED 200 using a tube 202 to prevent saturation. Tube 202 may be constructed of any opaque material or may be hollow. Portions (or the entirety of) reference LED 200 and photo sensor 206 assembly can be surrounded (e.g., encased, enclosed, etc.) by a housing 204. According to an exemplary embodiment housing 204 is constructed of an opaque material such that interference from non reference LEDs (or other light sources) is limited. According to other various exemplary embodiments housing 204 may be constructed of a semi-opaque material and/or configured differently than shown in FIG. 2.

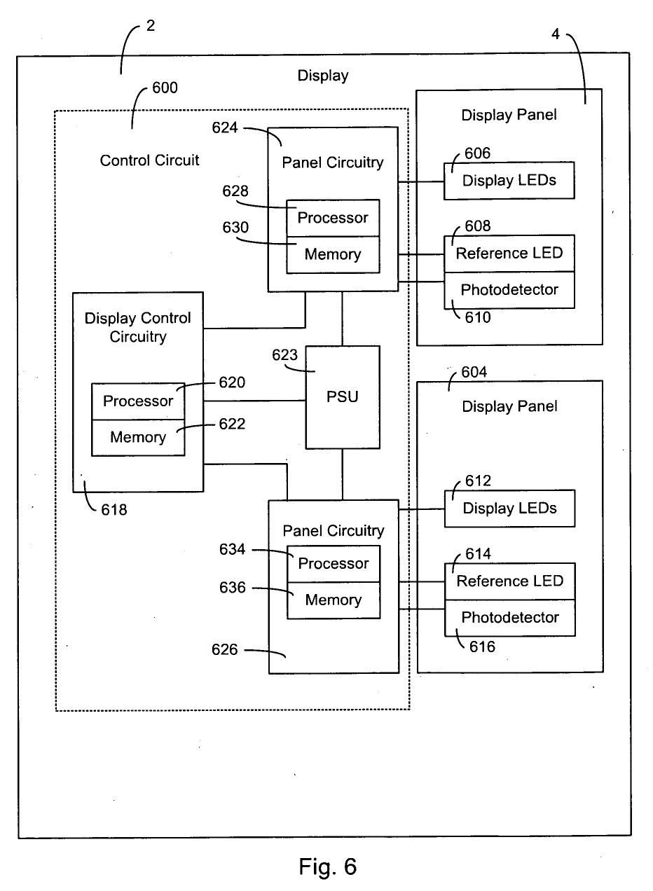

Referring to FIG. 6, a block diagram of display 2 is shown, according to an exemplary embodiment. Display 2 is shown to include display panel 4 and display panel 604. Many additional display panels not shown in FIG. 6 may be included with display 2. Display 2 is further shown to include control circuit 600 which may include a collection of hardware and/or software components. For example, display 2 is shown to include display control circuitry 618, panel circuitry 624 for display panel 4, panel circuitry 626 for display panel 604, and power supply unit (PSU) 623. Any number of additional boards and/or components may be included with control circuit 600 according to various exemplary embodiments.

Referring still to FIG. 6, display panel 4 is shown to include display LEDs 606, a reference LED 608, and a photodetector 610. According to an exemplary embodiment three groups of display LEDs, three reference LEDs, and three photodetectors are provided with display panel 4, one group, one reference LED, and one photodetector per diode color of display panel 4. Display panel 604 is shown similarly arranged, having display LEDs 612, reference LED 614, and photodetector 616. Display control circuitry 618 may correspond to video distributor 8 shown in FIG. 1. Display control circuitry 618 is shown to include processor 620 and memory 622. Display panel circuitry 624 is shown to include processor 628 and memory 630. Display panel circuitry 626 is shown to include processor 634 and memory 636. Processors 620, 628, and/or 634 may be of any suitable technology configured to accomplish the methods and/or method steps described herein. For example, the processors may be general purpose processors coupled to memory (e.g., memory 622, 630, 636) configured to store computer code and/or values that can be used by the general purpose processors. The processors can be and/or include application specific integrated circuits (ASICs), field programmable gate arrays (FPGAs), digital signal processors (DSPs), microcontrollers, filters, pulse-width modulation (PWM) drivers, timers, counters, filters, and/or any other suitable analog and/or digital components. Memory of the system can be volatile and/or non-volatile memory. PSU 623 can be any suitable power supply circuitry configured to provide power to the components of display 2. For example, PSU 623 may be a switched-mode power supply (SMPS), a linear regulator power supply, or otherwise.

Referring still to FIG. 6, panel circuitry 624, 626 may include constant current drivers for powering reference LEDs 608 and 614. The constant current drivers may be adjustable via pulse-width modulation (e.g., controlling the amount of time per video frame that an LED is on or off to effectively vary the current, and therefore intensity, during the frame to the driven LED). This configuration is the preferred manner in which to control or change current to the reference and display LEDs. More specifically, by changing the frequency and/or duration of the pulse width of the PWM signal, the time averaged current value is controllably changing. Display LEDs 606 and 612 and photodetector 610 and 616 may be similarly driven or driven via a different technology. Display control circuitry 618 may be configured to provide video data to panel circuitry 624 and 626. Panel circuitry 624 and 626 may then use the video data to determine how to drive the individual display LEDs of their respective display panels. It is important to note that control circuit 600 may be configured differently and that the reference LEDs and photodetectors for each panel may be largely separated from the circuitry used to drive the display LEDs.

Other methods and hardware configurations for effectively changing the current provided to the LEDs over a period of time can be used with the invention of the present application.

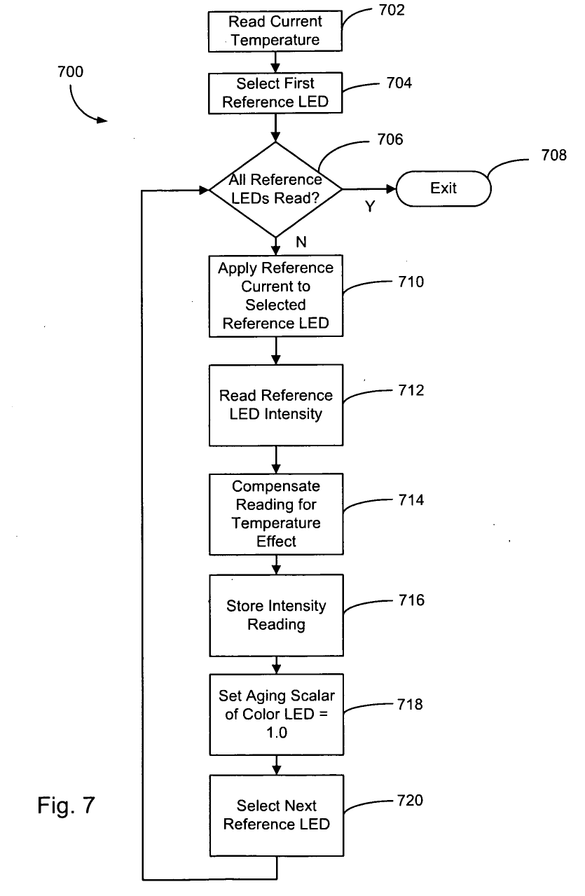

Referring to FIG. 7, a flow chart for completing an initial calibration process 700 is shown, according to an exemplary embodiment. Initial calibration process 700 may be run before the display is installed in an uncontrolled environment. Referring generally to FIG. 7, the reference LEDs are measured at a reference current using the photodetectors and a reference intensity reading is stored in non-volatile memory.

Process 700 is shown to include reading the current temperature (step 702) via an associated temperature sensor or another suitable method. Process 700 is shown to then select a first reference LED for calibration (step 704). According to an exemplary embodiment, step 704 of selecting a reference LED includes selecting one of a red, green, or blue reference LED installed on a display panel. If all reference LEDs have already been calibrated (determination step 706), the process may exit (step 708). Otherwise, a reference current may be applied to the selected reference LED (step 710). According to an exemplary embodiment the reference current approximates the current expected to be typically used to drive the display LEDs. Process 700 is shown to include reading the intensity of the reference LED when the reference current is applied (step 712).

Referring to the exemplary embodiment shown in process 700, the system can adjust the intensity to compensate for temperature that may be affecting the performance of the LED and/or the photodetector (step 714). Compensating for temperature changes that may affect the calibration readings may include multiplying any read values by some value determined to account for variances due to temperature. Indicia of the intensity read in step 712 may then be stored (step 716) as an original intensity value in memory (e.g., memory shown in FIG. 6). When the intensity reading is stored, an aging scalar of the reference LED may be set to one (step 718) or another value. The next reference LED may then be selected (step 720) and the process will loop back to determination step 706.

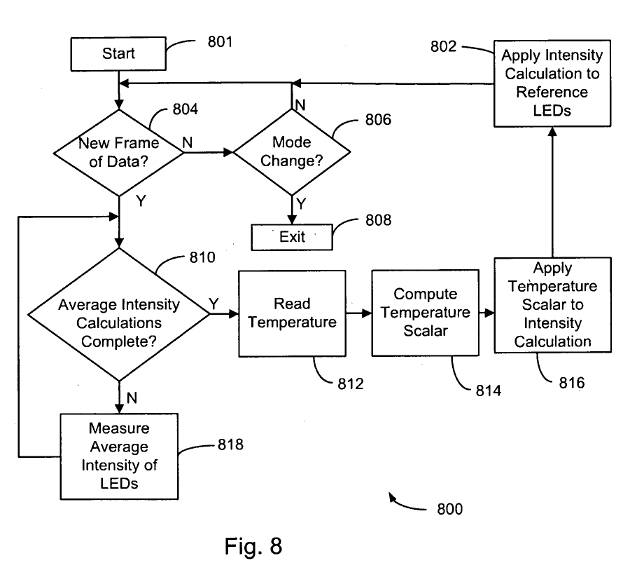

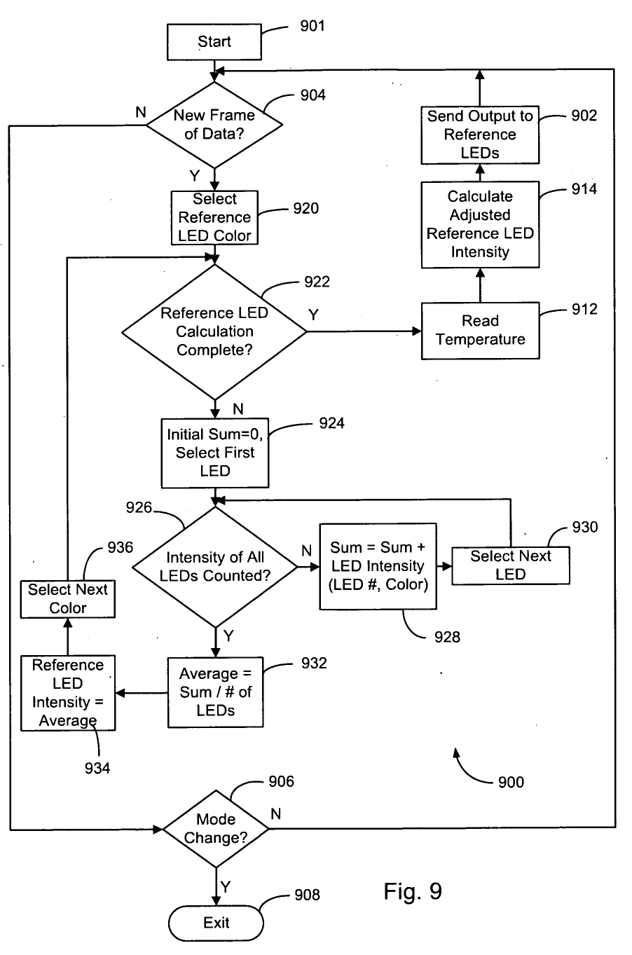

Referring to FIG. 8, a flow chart of a process 800 for normal operation of a display panel is shown, according to an exemplary embodiment. Process 800 may be started (step 801) after (or before) calibration process 700. Video may be provided to display panels in frames (video data that is displayed for a short period of time). Step 804 may determine whether a new frame of data has been received from the video distributor. If a new frame of data has not been received from the video distributor, the system may determine whether a mode change has been commanded (e.g., via a video distributor or another circuit) (step 806). For example, the control circuit will periodically place the system into a calibration mode or procedure (e.g., the process shown in FIG. 9). If a mode change has been detected, the system may exit (step 808). If a mode change has not been detected at step 806, the system will continue checking for a new frame a data at step 804. During the displaying of data on the display panel, the average intensity applied to the display LEDs will be calculated for each color (step 818). If the decision at step 804 is positive, the control circuit will determine whether average intensity calculations are complete (step 810). Step 810 may include averaging the current applied to the display LEDs given the updated frame data. It is important to note that other indicia of the relationship between current applied to the display LEDs and intensity may be determined or calculated by the system. For example, the control circuit can be configured to calculate the percentage of display LEDs that were on during a frame for more than 50% of the frame time, calculate the percentage of display LEDs that were approaching full intensity during a given frame, calculate the probability that display LEDs were near full intensity for two or more consecutive frames, or the like. If average intensity calculations are determined to be complete at step 810, process 800 is further shown to read the temperature (step 812). Temperature (e.g., a temperature measurement, a signal that can be used to derive temperature, etc.) may be read via by receiving a signal from a temperature sensor at the display panel as previously described or otherwise. Based on the received signal relating to temperature, a temperature scalar may be computed (step 814). The temperature scalar may be computed by applying a predetermined equation to the temperature reading for each LED color, by using a look-up table of temperature ranges to intensity change, or otherwise. Once calculated, the temperature scalar may be applied to an intensity calculation for the reference LED of the display panel (step 816) and the intensity calculation may be applied to the reference LEDs (step 802). In other words, process 800 may be configured to ensure that the “life” experience of the reference LEDs of the board approximates that of the display LEDs during any given frame. Steps 816 and 802 may operate to adjust the current applied to the reference LED to approximate the current applied to the average display LED. According to various exemplary embodiments, process 800 is applied for reference LED and/or diode color group of a display panel.

Referring now to FIG. 9, a detailed flow chart of a process 900 for normal operation of a display panel is shown, according to an exemplary embodiment. Process 900 is a more detailed flow-chart of process 800 shown in FIG. 8 with steps 901-916 corresponding to steps 801-816 of FIG. 8. Process 900 further includes the step of selecting a reference LED color (step 920) and looping through multiple other reference LED colors (e.g., 3). Step 922 determines whether the reference LED calculation is complete, and sets a sum variable to zero and selects a first display LED from the display LED color group corresponding to the LED reference color selected in step 920 if reference LED calculations are determined to not be complete (step 924). The control circuit will then add an LED intensity indicia (e.g., LED color value, current value, voltage value, etc.) to the sum variable (step 928), select the next LED (step 930), and loop by checking whether the intensity of all LEDs have been counted (step 926). Once the intensity from all LEDs have been counted (checked via step 926) the control circuit will calculate the average intensity for the display LEDs (step 932) and set the reference LED intensity to equal the average intensity of the display LEDs on the display board (e.g., during a given frame, over multiple frames, etc.) (step 934). According to other various exemplary embodiments, the control circuit is configured to drive the reference LED at a current approximating (e.g., within 25% of the average, within 15 percent of average, within 5 percent of average, etc.) the average current applied to the display LEDs. A next reference LED color will then be selected (step 936), the sum variable will be set to zero again, and the process will repeat until all reference LED colors are processed. It is important to note that the reference LED calculation process can be run in parallel for multiple reference LED colors and/or display boards.

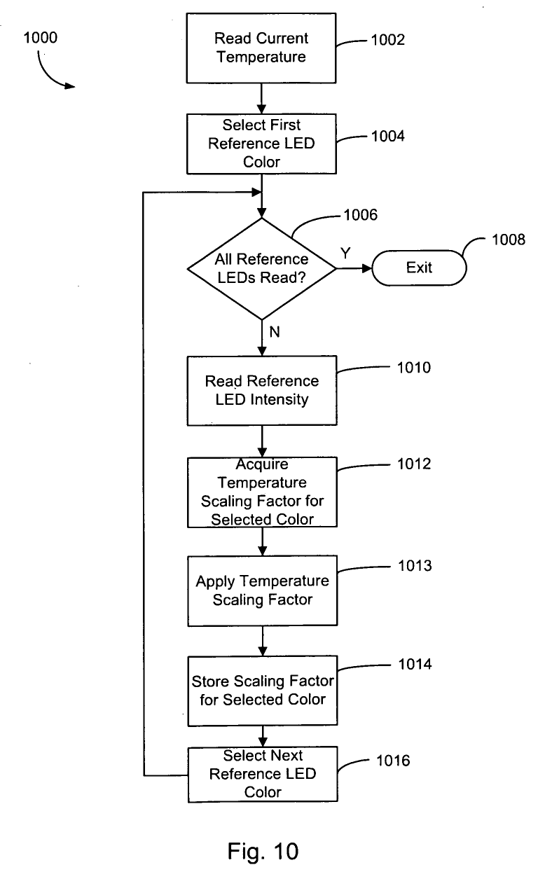

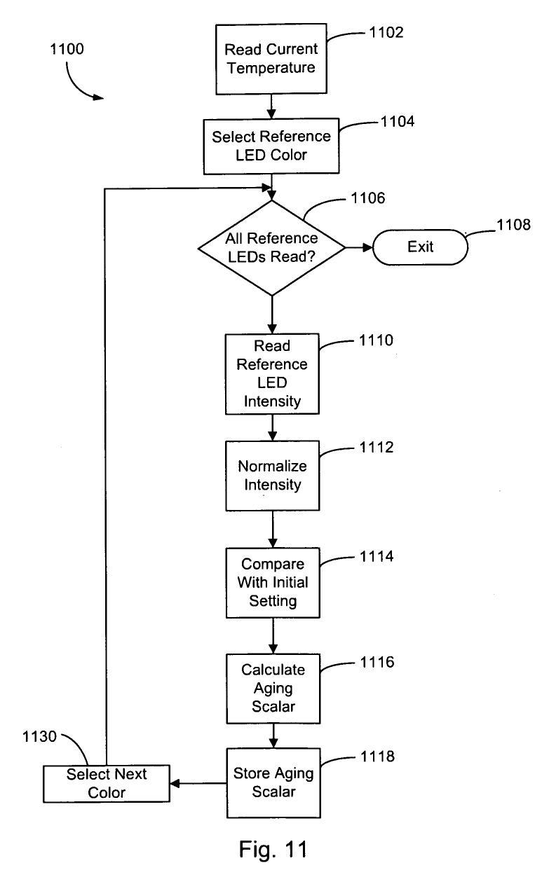

Referring now to FIG. 10, a flow chart of a temperature compensation process 1000 is shown, according to an exemplary embodiment. Temperature compensation process 1000 is generally configured to correct for intensity (color) change due to temperature variant characteristics of red, green, and blue LEDs. Temperature compensation process 1000 may be conducted at a faster rate (e.g., more frequently) than the aging compensation process shown in FIG. 11. In other words, the control circuit is configured to adjust the current provided to the LEDs of an LED color group based on temperature at a faster rate than the circuit adjusts the current provided to the LEDs of the LED color group. For example, temperature compensation process 1000 may be executed every 10-30 minutes while the aging compensation process may be conducted less frequently (e.g., once a day, once a week, once a month, etc.).

Referring still to FIG. 10, process 1000 is shown to include the step of reading the current temperature (step 1002). The temperature may be read from the temperature sensor and/or from memory after a signal received from a temperature sensor is interpreted by the control circuit. Process 1000 may be configured to loop through all the reference LEDs for each reference LED color (if more than one reference LED per color). When process 1000 is first executed, the control circuit will select the first reference LED color (step 1004). The control circuit can then decide whether all reference LEDs have been read (step 1006) and exit (step 1008) if all reference LEDs have in fact been read. During process 1000 the control circuit will be configured to apply a reference current to the selected reference LED and to read the reference LED intensity (step 1010) related to the reference current. Process 1000 is further shown to include the step of acquiring the temperature scaling factor for the selected color (step 1012). Acquiring the temperature scaling factor for the selected color may include comparing actual conditions to a pre-stored temperature model (e.g., photodetector current vs. ambient temperature) or equation. Such a model may be configured to account for the way that temperature affects the photodetector as well as the reference LED, the model configured to remove any effect produced by the photodetector from the equation relating to reference current, temperature, and actual intensity. Once the temperature scaling factor is found, it may be applied to the display LEDs (step 1013) during normal operation of the display LEDs for the selected color and stored in memory (step 1014). The next reference LED color may then be selected (step 1016) and the process loops back to step 1006.

Referring now to FIG. 11, a flow chart of an aging compensation process 1100 is shown, according to an exemplary embodiment. Process 1100 shown in FIG. 11 may be performed every week or month. Process 1100 may also be performed during normal operation without interrupting operation of the display. Process 1100 is shown to begin by reading the current temperature in step 1102 and selecting a reference LED color in step 1104. Process 1100 loops via step 1106 which determines whether all reference LEDs have been read (exiting at step 1108 if they have), and step 1130 which selects the next reference LED color after steps 1110-1118 have been completed. At step 1110 process 1100 reads the reference LED intensity when a reference current is applied to the reference LED. The intensity signal may then be normalized for temperature affecting the photodetector and/or reference LED (step 1112). For example, the control circuit may be configured to normalize the signal to a room temperature of 25 degrees Celsius. The normalized signal can then be compared with the initial setting (step 1114). The initial intensity reading can be the reading stored in FIG. 7 in step 716. Based on the comparison the control circuit will then calculate an aging scalar (e.g., aging scaling factor) (step 1116). According to an exemplary embodiment the circuit calculates the aging scalar in a way that is configured to compensate for changes in the relationship between the intensity of reference LED and the applied reference current. The aging scaling factor can then be stored in memory (step 1118) for use during normal activity of the display LEDs and/or immediately applied to the display LEDs. The application of the new aging scaling factor may adjust and/or update the aging scaling set in FIG. 7 in step 718. The new current/intensity relationship may be stored for use in future comparison step 1114 activities. Using process 1100 the (and/or the other processes described herein), the control circuit can compensate for temperature and age induced changes in the relationship between the intensity of the display LEDs and the applied current applied to the display LEDs.

Referring again generally to the Figures, the reference current may be full current or some other preset current value. Further, color calibration and aging calibration processes described herein need not stop the normal operation of the display LEDs. In other words, the compensation process can be executed on the fly (e.g., in near real time) without an observable break in display operation.

According to any preferred embodiment, three reference LEDs are provided to each LED display panel mounted in a display sign. One reference LED is provided for each LED color on the display board. Each reference LED is paired with a photodetector. The reference LEDs will be of the same characteristics as the other same color LEDs populating the display panel. The reference LEDs are optically coupled to the photodetector using a tube with a small orifice so that the photodetector will not saturate. This tube will not allow outside light to influence the measurement of the photodetector. The reference LEDs are mounted inside the display, according to a preferred embodiment. The reference LEDs are driven with a circuit including a constant current driver. The photodetectors and a temperature sensor are communicably coupled to the circuit (or a different circuit). The circuit is configured to correct for color offset due to operating temperature. The circuit is configured to adjust during normal operation of the display. The circuit is further configured to compensate for LED aging effects. After the display has been running for some time, the display will go through self-calibration cycles for temperature and/or aging compensation. The calibration cycles may rely on initial calibration processes. The calibration cycles rely on considering the relationship between intensity of a reference LED given a reference current. The system can also calibrate the photodetector based on a measurement received from the temperature sensor. Because the reference LED experiences a service life similar to that of the display LEDs to which it relates, Applicants have found that their compensation cycles improve sign performance and image consistency during temperature changes and over the life of the display.

The figures discussed above illustrate an exemplary embodiment in detail. It should be understood that the application is not limited to the details or methodology set forth in the description or illustrated in the figures. It should also be understood that the terminology is for the purpose of description only and should not be regarded as limiting.

While the exemplary embodiment(s) illustrated in the figures and described herein is presently preferred, it should be understood that the embodiment(s) is offered by way of example only. Accordingly, the present application is not limited to a particular embodiment, but extends to various modifications that nevertheless fall within the scope of the appended claims.

The construction and arrangement of the systems and methods as shown are illustrative only. Although only one or a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. All such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

Embodiments within the scope of the present disclosure include program products comprising machine-readable media for carrying or having machine-executable instructions or data structures stored thereon. For example, the methods described could be programmed as computer code on a machine-readable medium for transfer to and/or installation on a circuit configured to execute the computer code. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A display for generating changing or still images, the display comprising:
a plurality of display light emitting diodes (LEDs), each display LED generating light at an intensity related to current applied thereto;
a circuit which controls the current applied to each display LED to generate at least a portion of an image on the display, wherein the current is changed to change the portion of the image;
a reference LED coupled to the circuit, wherein the circuit applies a current to the reference LED dependent upon the current applied to at least one display LED, the circuit periodically applying a reference current to the reference LED; and
a detector optically coupled to the reference LED to generate an intensity signal representative of the intensity of the reference LED when the reference current is applied thereto, the circuit monitoring the intensity signal to control the current applied to the display LEDs to compensate for changes in the relationship between the intensity of display LEDs and the current applied to the display LEDs.

2. The display of claim 1, wherein the display LEDs include a plurality of groups of LEDs with each group having a different color, and each group being associated with at least one reference LED.

3. The display of claim 1, wherein the circuit stores indicia of an original intensity of the reference LED at the reference current, the circuit utilizing the intensity signal to compare the intensity of the reference LED to the original intensity and controlling the current applied to the display LEDs based upon such comparison.

4. A light emitting diode (LED) display, comprising:
a reference LED corresponding to an LED color group of the display;
a circuit configured to drive the reference LED at an indicia of the intensity of the LEDs of the LED color group, wherein the circuit is configured to vary the current provided to the reference LED with changes in the indicia of the intensity of the LEDs of the LED color group; and
a photodetector configured to measure the intensity of the light emitting from the reference LED when the circuit is driving the reference LED at a reference current level;
wherein the circuit is configured to compare the measured intensity to a stored, calculated, or stored and calculated intensity value determined to correspond with the reference current, and wherein the circuit is configured to adjust the current provided to the LEDs of the LED color group of the display based on the comparison.

5. The LED display of claim 4, wherein the indicia of the intensity of the LEDs of the LED color group is an average intensity.

6. The LED display of claim 4, further comprising:
a sensor configured to measure temperature, wherein the circuit is further configured to adjust the current provided to the LEDs of the LED color group based on temperature.

7. The LED display of claim 6, wherein the circuit is further configured to compensate for the effect that temperature has on the photodetector.

8. The LED display of claim 6, wherein the circuit is configured to adjust the current provided to the LEDs of the LED color group based on temperature at a faster rate than the circuit adjusts the current provided to the LEDs of the LED color group based on the comparison.

9. The LED display of claim 4, wherein the photodetector and the reference LED are coupled via a housing configured to prevent light from sources other than the reference LED from being measured by the photodetector.

10. A method for adjusting light emitter diode (LED) intensity of a display having a plurality of LEDs, comprising:
driving the plurality of LEDs;
driving a first LED coupled to the display at a first intensity approximating a measure of the intensity of the plurality of LEDs;
measuring the intensity of the light emitting from the first LED when the first LED is driven at a first reference current using a photodetector;
comparing the measured intensity of the light emitting from the first LED to a first stored intensity level; and
using the comparison to adjust the current provided to the plurality of LEDs.

11. The method of claim 10, further comprising:
determining the first intensity by calculating an average intensity of the plurality of LEDs.

12. The method of claim 10, wherein the plurality of LEDs correspond to a first diode color of the display.

13. The method of claim 10, further comprising:
determining the first intensity by calculating an average current provided to the plurality of LEDs.

14. The method of claim 10, further comprising:
receiving a temperature measurement for the display from a temperature sensor; and
adjusting the current provided to the plurality of LEDs based on the temperature measurement.

15. The method of claim 14, further comprising:
compensating for the effect that temperature has on the photodetector.

16. A system for adjusting light emitting diode (LED) intensity of a display having a plurality of LEDs, the system comprising:
a first LED at the display;
a circuit which determines an indicia of the current applied to the plurality of LEDs and to cause the first LED to be driven at a first current related to the indicia of current applied to the plurality of LEDs; and
a first photodetector configured to periodically measure the intensity of the light emitting from the first LED when the first LED is driven at a first reference current, wherein the circuit is further configured to compare the measured intensity of the light emitting from the first LED to a first stored intensity level, and wherein the 11 circuit is further configured to use the comparison to adjust the current provided to the plurality of light emitting diodes.

17. The system of claim 16, wherein the plurality of LEDs correspond to a first diode color.

18. The system of claim 17, further comprising:
a second group of LEDs coupled to the display and corresponding to a second diode color;
a second LED coupled to the display, wherein the circuit is configured to determine a second indicia of the current applied to the second group of LEDs and to cause the second LED to be driven at a second current approximating the second indicia of the current applied to the second group of LEDs; and
a second photodetector configured to measure the intensity of the light emitting from the second LED when the second LED is driven at a second reference current, wherein the circuit is further configured to compare the measured intensity of the light emitting from the second LED to a second stored intensity level, and wherein the circuit is further configured to use the comparison to adjust the current provided to the plurality of LEDs.

19. The system of claim 18, further comprising:
a third group of LEDs coupled to the display and corresponding to a third diode color;
a third LED coupled to the display, wherein the circuit is configured to determine a third indicia of the current applied to the third group of LEDs and to cause the third LED to be driven at a third current approximating the third indicia of the current applied to the third group of LEDs; and
a third photodetector configured to measure the intensity of the light emitting from the third LED when the third LED is driven at a third reference current, wherein the circuit is further configured to compare the measured intensity of the light emitting from the third LED to a third stored intensity level, and wherein the circuit is further configured to use the comparison to adjust the current provided to the plurality of LEDs in a third period of time.

20. The system of claim 16, wherein the indicia of the current provided to the first group of LEDs is an based on an average intensity or an average current for the first group of LEDs.

21. The system of claim 19, wherein the first diode color is red, the second diode color is green, and the third diode color is blue.

22. The system of claim 16, further comprising:
a temperature sensor;
wherein the circuit is further configured to calibrate the first photodetector based on a measurement from the temperature sensor; and
wherein the circuit is further configured to normalize the measured intensity of light emitting from the first LED based on another measurement from the temperature sensor.

23. The system of claim 22, wherein the circuit is further configured to adjust the current provided to the plurality of LEDs based on the measurement from the temperature sensor.
